(19) United States
(12) Patent Application Publication
(10) Pub. No.: US 2011/0105045 A1
(43) Pub. Date: May 5, 2011

(54) RADIO TRANSMISSION METHOD, RADIO TRANSMISSION SYSTEM, RADIO RECEIVER AND RADIO TRANSMITTER

(76) Inventor: Koichiro Tanaka, Hyogo (JP)

(21) Appl. No.: 13/003,639

(22) PCT Filed: Mar. 31, 2010
(86) PCT No.: PCT/JP2010/002370

§ 371 Date: Jan. 11, 2011

(30) Foreign Application Priority Data
Apr. 9, 2009 (JP) 2009-094949

(51) Int. Cl. H04B 7/02; H04B 17/00

(52) U.S. Cl. 455/67.11; 455/101

(57) ABSTRACT

A radio transmission system is provided comprising vertically polarized antennas and horizontally polarized antennas which form a plurality of transmission paths which perform a radio data transmission, a communication condition measuring unit which detects that at least a part of transmission paths becomes unavailable for use, and a search unit which searches or sets, depending on a detecting result of the detecting unit, another alternative transmission path instead of the part of transmission paths which becomes unavailable for use. The search unit searches the alternative transmission path by using search results of a part or all of transmission paths other than the part of transmission paths which is blocked.

### CROSS-REFERENCE TO RELATED APPLICATIONS

This application is a U.S. national phase application of PCT International Patent Application No. PCT/JP2010/002370 filed Mar. 31, 2010, claiming the benefit of priority of Japanese Patent Application No. 2009-094949 filed Apr. 9, 2009, all of which are incorporated by reference herein in their entirety.

### TECHNICAL FIELD

The present invention relates to a radio transmission method, a radio transmission system, a radio receiver and a radio transmitter which perform radio transmission by using a polarization multiplexing or a spatial multiplexing for example.

### BACKGROUND ART

In recent years, transmitting data such as non-compression video by radio has been performed. It is advantageous to use a millimeter-wave which can use a large frequency band to transmit data of such a broadband. However, the millimeter-wave whose frequency is high is strong in going straight characteristics, and such a millimeter wave has a property that communication is easy to break off when an obstacle such as a human enters between a transmission apparatus and a reception apparatus. Beamforming to continue communication by using the reflection wave from structures such as a floor or a wall when a direct wave is blocked has been thought about to overcome this property (in the case of indoors). The beamforming is performed by sharpening the directivities of a sending antenna and a receiving antenna. That is, the beamforming is performed by rising gains of antennas.

When beamforming is used, it is necessary to shorten times for a search and setting of the beam direction. As an example to do so, there is the following method (see, for example, WO2008/090836 (for example, Page 2-Page 6, FIG. 4 and FIG. 5)). The method is that, when the next beam direction is searched after a beam direction where the best communication quality was provided is blocked, adjacent beam direction is not given high priority because it is likely that the direction is blocked equally.

### DISCLOSURE OF THE INVENTION

### Problems to be Solved by the Invention

The above conventional technique is a technique for the case that a radio data transmission is performed by using a single transmission path between the sending side and the receiving side. On the other hand, the polarization multiplexing or the spatial multiplexing is useful to make data to transmit by radio more broadband. These are communication methods in which a plurality of antennas are prepared and multiplex communication of information is performed by using a plurality of space transmission paths corresponding with the plurality of antennas.

However, as specializing such multiplex communication, a technique that searches a beam when a transmission path is blocked is not disclosed conventionally. That is, as specializing such multiplex communication, the technique to shorten a time to search for another transmission path which should be used newly is not disclosed conventionally.

It is an object of the present invention to, taking into account the problems mentioned above, obtain a radio transmission method, a radio transmission system, a radio receiver and a radio transmitter which are able to shorten a time to search for a transmission path for another transmission path which is blocked while a radio data transmission is performed by using a plurality of transmission paths.

### SUMMARY OF THE INVENTION

The 1^{st} aspect of the present invention is a radio transmission method comprising:

a step of searching or setting, when a radio data transmission is performed by using a plurality of transmission paths which form a polarization multiplexing or a spatial multiplexing and at least a part of the plurality of transmission paths becomes unavailable for use, another alternative transmission path instead of the part of the plurality of transmission paths which becomes unavailable for use, by using search results already obtained as to a part or all of a plurality of transmission paths other than the part of the plurality of transmission paths which becomes unavailable for use.

The 2^{nd} aspect of the present invention is a radio transmission system comprising:

a plurality of antennas which form a plurality of transmission paths which perform a radio data transmission by using a polarization multiplexing or a spatial multiplexing;

a detecting unit which detects that at least a part of the plurality of transmission paths becomes unavailable for use when the radio data transmission is performed by using the plurality of transmission paths; and

a search unit which searches or sets, depending on a detecting result of the detecting unit, another alternative transmission path instead of the part of the plurality of transmission paths which becomes unavailable for use, wherein

the search unit searches or sets the alternative transmission path by using search results already obtained as to a part or all of a plurality of transmission paths other than the part of the plurality of transmission paths which becomes unavailable for use.

The 3^{rd} aspect of the present invention is the radio transmission system according to the 2^{nd} aspect of the present invention, wherein

the plurality of antennas which form the plurality of transmission paths are arranged at least on a sending side or on a receiving side of the data; and

when the search unit searches or sets, the search unit searches or sets the alternative transmission path by changing directivity of antennas of the sending side and/or antennas of the receiving side which form the part of the plurality of transmission paths which becomes unavailable for use, by using directivity which is a search result of antennas of the sending side and/or antennas of the receiving side which form the part or all of the plurality of transmission paths other than the part of the plurality of transmission paths which becomes unavailable for use.

The 4^{th} aspect of the present invention is the radio transmission system according to the 3^{rd} aspect of the present invention, wherein

when the search unit searches or sets, the search unit sets directivity of antennas of the sending side and/or antennas of the receiving side which is a search result of the part or all of the plurality of transmission paths other than the part of the plurality of transmission paths which becomes unavailable for use in initial directivity of the antennas of the sending side and/or the antennas of the receiving side at the beginning of the search for the alternative transmission path.

The 5^{th} aspect of the present invention is the radio transmission system according to any one of the 2^{nd} to the 4^{th} aspects of the present inventions, wherein

the detecting unit and the search unit are arranged on the sending side or on the receiving side of the data at least.

The 6^{th} aspect of the present invention is the radio transmission system according to any one of the 2^{nd} to the 5^{th} aspects of the present inventions, wherein

the plurality of antennas which form the plurality of transmission paths are arranged with regard to position relations to have a mirror image relationship to each other between the sending side and the receiving side.

The 7^{th} aspect of the present invention is the radio transmission system according to any one of the 2^{nd} to the 5^{th} aspects of the present inventions, wherein

the plurality of antennas which form the plurality of transmission paths are arranged with regard to position relations to make a non-parallel relationship to each other between the sending side and the receiving side.

The 8^{th} aspect of the present invention is a radio receiver comprising:

an antenna which is used to form a plurality of transmission paths which perform a radio data transmission by using a polarization multiplexing or a spatial multiplexing, against a sending side;

a detecting unit which detects that at least a part of the plurality of transmission paths becomes unavailable for use when the radio data transmission is performed by using the plurality of transmission paths; and

a search unit which searches or sets, depending on a detecting result of the detecting unit, another alternative transmission path instead of the part of the plurality of transmission paths which becomes unavailable for use, wherein

the search unit searches or sets the alternative transmission path formed against the sending side by using search results already obtained as to a part or all of a plurality of transmission paths other than the part of the plurality of transmission paths which becomes unavailable for use.

The 9^{th} aspect of the present invention is a radio transmitter comprising:

an antenna which is used to form a plurality of transmission paths which perform a radio data transmission by using a polarization multiplexing or a spatial multiplexing, against a receiving side;

a notified unit which receives from the receiving side a notification showing that at least a part of the plurality of transmission paths becomes unavailable for use when the radio data transmission is performed by using the plurality of transmission paths; and

a search unit which searches or sets, depending on a performance of the notified unit, another alternative transmission path instead of the part of the plurality of transmission paths which becomes unavailable for use, wherein

the search unit searches or sets the alternative transmission path formed against the receiving side by using search results already obtained as to a part or all of a plurality of transmission paths other than the part of the plurality of transmission paths which becomes unavailable for use.

The 10^{th} aspect of the present invention is a non-transitory computer-readable medium having a program stored thereon, wherein the program causes a computer to execute the radio transmission method according to the 1^{st} aspect of the present invention.

According to the present invention, a time before a search being completed is shortened. Furthermore, intersecting a plurality of transmission paths in space is prevented.

### Advantage of the Invention

According to the present invention, it is possible to shorten a time to search for an alternative transmission path for another transmission path which is blocked by using a polarization multiplexing or a spatial multiplexing while a radio data transmission is performed by using a plurality of transmission paths.

### BRIEF DESCRIPTION OF THE DRAWINGS

FIG. 1 illustrates a configuration example of a radio transmission apparatus according to the first embodiment of the present invention;

FIG. 2 illustrates a flowchart showing an operation example of transmission path searches according to each embodiment of the present invention;

FIG. 3 illustrates diagrams showing desirable layout examples of antennas;

FIG. 4 illustrates a configuration example of a radio transmission apparatus according to the second embodiment of the present invention;

FIG. 5 illustrates a configuration example of a radio apparatus of the receiving side according to the third embodiment of the present invention; and

FIG. 6 illustrates a configuration example of a variation of the radio communications units according to the present invention.

### MODE FOR CARRYING OUT THE INVENTION

Embodiments of the present invention will be described below with reference to the drawings.

### First Embodiment

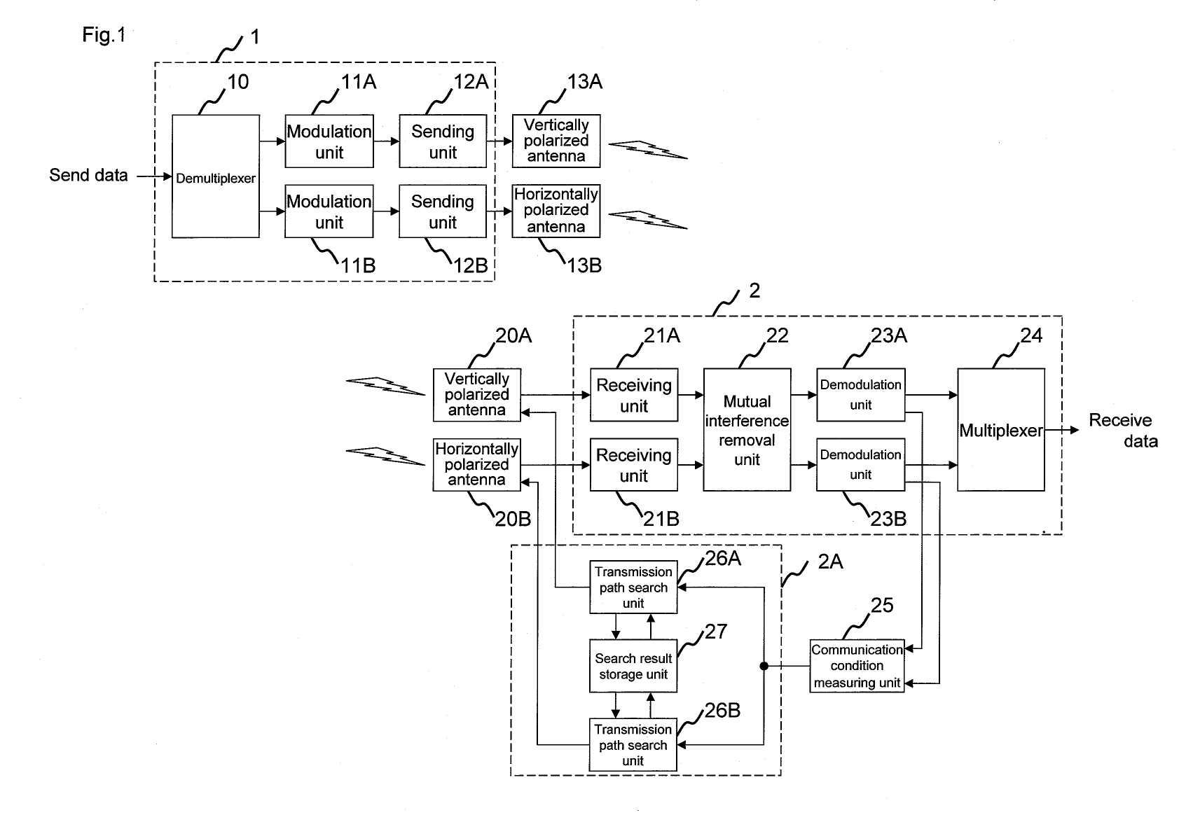

FIG. 1 is a block diagram of a radio transmission apparatus according to a first embodiment of the present invention. In the present embodiment, a fixed-directivity antenna is used on a radio sending side and a variable-directivity antenna is used on a radio receiving side.

The sending side is a radio apparatus which includes a radio communications unit 1 which in turn includes a demultiplexer 10, modulation units 11A and 11B, and sending units 12A and 12B; and a vertically polarized antenna 13A and horizontally polarized antenna 13B connected, respectively, to the sending units 12A and 12B of the radio communications unit 1.

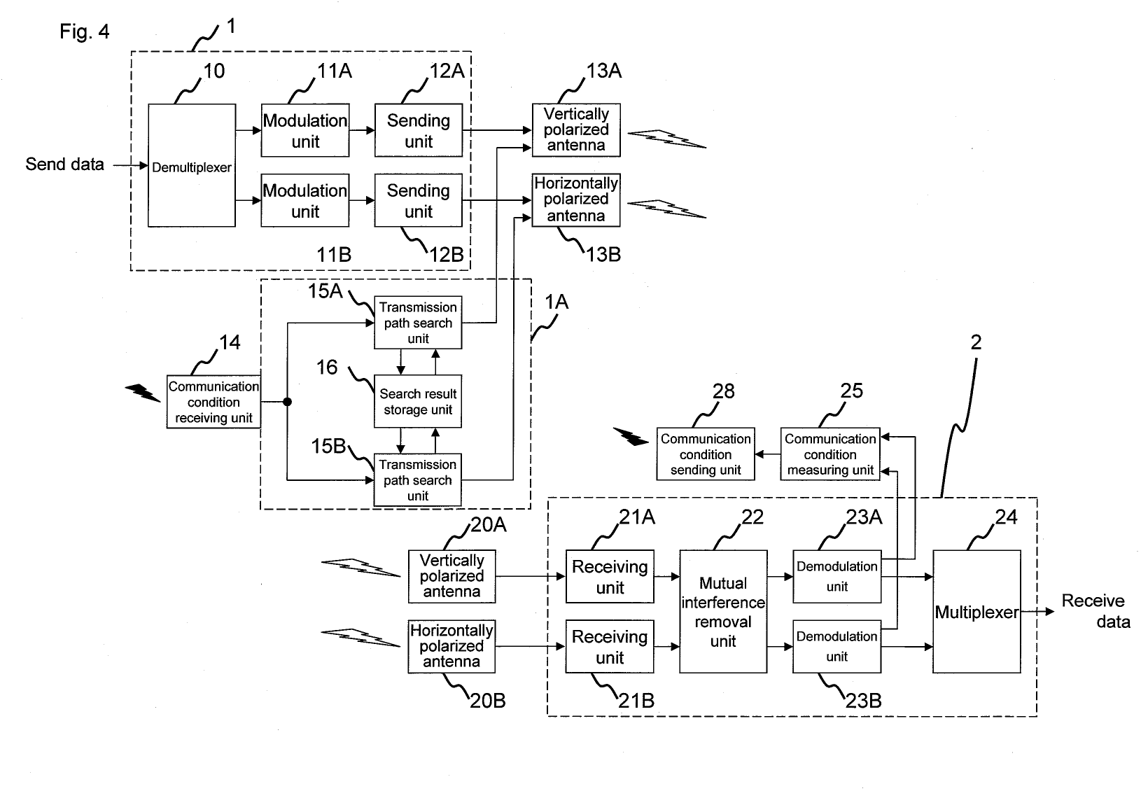

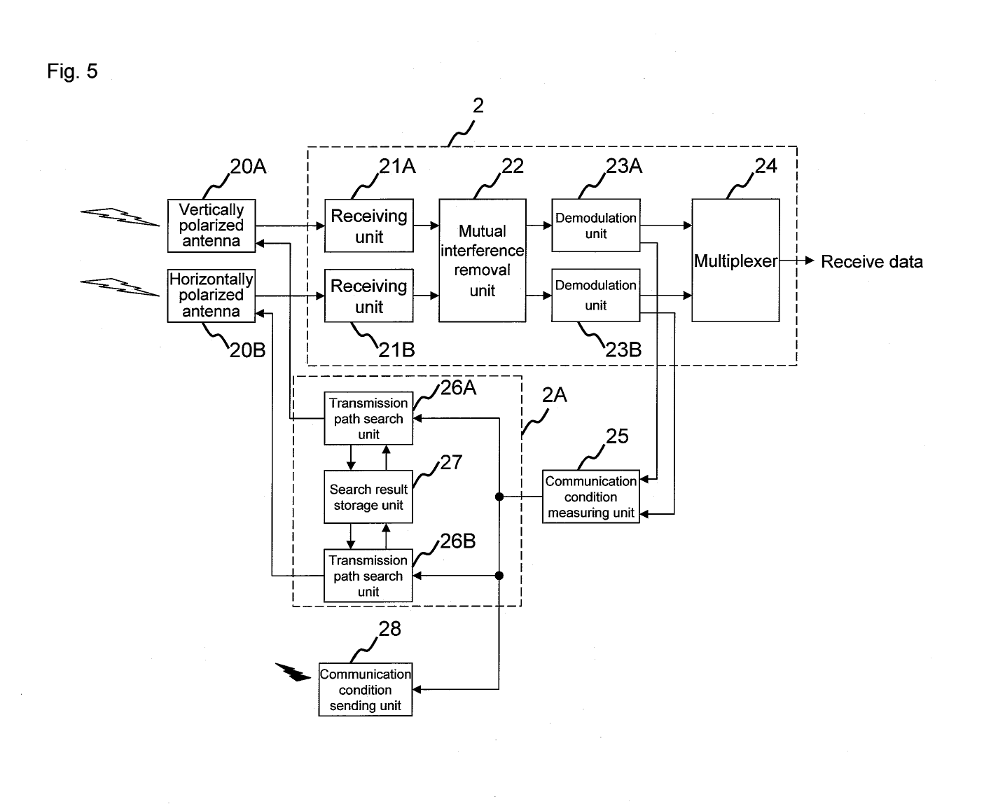

The receiving side is a radio apparatus which includes a radio communications unit 2 which in turn includes receiving units 21A and 21B, a mutual interference removal unit 22, demodulation units 23A and 23B, and a multiplexer 24; and a vertically polarized antenna 20A and horizontally polarized antenna 20B connected, respectively, to the receiving units 21A and 21B of the radio communications unit 2; a communication condition measuring unit 25; and a search unit 2A which in turn includes transmission path search units 26A and 26B and a search result storage unit 27. Although a single group of signal lines are shown as running from the communication condition measuring unit 25 to the transmission path search units 26A and 26B so that the transmission path search units 26A and 26B will select necessary signals, two groups of signal lines from the communication condition measuring unit 25 may be connected respectively to the transmission path search units 26A and 26B. This also applies to FIGS. 4 and 5 described later.

Basic operation of the radio transmission apparatus described above is as follows. In the radio communications unit 1, send data desired to be transmitted is inputted in the demultiplexer 10, which divides the send data into two series of data with lower transmission rates. Based on the respective series of data, the modulation units 11A and 11B generate respective modulated signals using a modulation method such as QPSK or 16 QAM. The sending units 12A and 12B convert the respective modulated signals into signals in a radio frequency band such as the millimeter-wave band. The vertically polarized antenna 13A radiates the signal in the radio frequency band outputted by the sending unit 12A, into space. The horizontally polarized antenna 13B radiates the signal in the radio frequency band outputted by the sending unit 12B, into space.

The vertically polarized antenna 20A on the receiving side receives the signal radiated from the vertically polarized antenna 13A on the sending side and propagated via a transmission path in space. The horizontally polarized antenna 20B on the receiving side receives the signal radiated from the horizontally polarized antenna 13B on the sending side and propagated via a transmission path in space. Ideally signals whose polarized waves are orthogonal to each other do not interfere with each other. Actually, however, the signals interfere with each other to some extent due to displacement in orientation of the antennas or influence of reflecting objects located near the transmission paths. In the radio communications unit 2, the receiving units 21A and 21B amplify the signals from the vertically polarized antenna 20A and horizontally polarized antenna 20B, respectively, and convert the signals into baseband signals convenient for subsequent signal processing. The mutual interference removal unit 22 removes interference between the baseband signals from the receiving units 21A and 21B. Generally, mutual interference can be expressed by matrix multiplication, and thus can be removed by multiplying the signals by the inverse matrix.

The demodulation units 23A and 23B demodulate the two groups of the baseband signals from which the mutual interference has been removed, using a modulation method such as QPSK or 16 QAM, and output resulting data. The multiplexer 24 integrates the data outputted by the demodulation units 23A and 23B, thereby reproduces data with a high transmission rate and outputs the data as receive data to outside the radio communications unit 2.

In the above configuration, the radio transmission apparatus corresponds to a radio transmission system according to the present invention. Also, the radio apparatus made up of the radio communications unit 2, vertically polarized antenna 20A, horizontally polarized antenna 20B, communication condition measuring unit 25, and search unit 2A corresponds to the receiving side according to the present invention as well as to a radio receiver according to the present invention. Also, the radio apparatus on the sending side including the radio communications unit 1 corresponds to the sending side according to the present invention. Also, the vertically polarized antenna 20A and horizontally polarized antenna 20B correspond to a plurality of antennas on the receiving side according to the present invention while the vertically polarized antenna 13A and horizontally polarized antenna 13B correspond to a plurality of antennas on the sending side according to the present invention. These antennas correspond to a plurality of antennas which form a plurality of transmission paths according to the present invention.

Now, description will be given of configuration and operation involved in searches for transmission paths, of the radio transmission system according to the first embodiment of the present invention, thereby describing an embodiment of a radio transmission method and radio receiver according to the present invention.

Based on conditions of the demodulation units 23A and 23B, the communication condition measuring unit 25 measures whether or not communication conditions of a transmission path formed between the vertically polarized antenna 13A and vertically polarized antenna 20A as well as a transmission path formed between the horizontally polarized antenna 13B and horizontally polarized antenna 20B are good. The communication conditions of the demodulation units 23A and 23B are represented, for example, by received signal strength, S/N ratios of the received signals, bit error rates of demodulated data, and packet error rates of the demodulated data. Whether or not communication conditions are good corresponds to the extent to which transmission paths according to the present invention become unavailable for use, and is defined by quantitatively evaluating the possibility of data transmission, quality of the transmitted data, and the like. That the communication conditions are not good (the transmission paths are unavailable for use) means a state in which data transmission is disabled, a state in which data quality is poor due to a bit error or packet error in excess of a certain value, or the like. In the following description, as an example of a case in which the communication conditions are not good, the communication condition measuring unit 25 measures a state in which data transmission is disabled, i.e., a state in which a transmission path is blocked.

The vertically polarized antenna 20A and horizontally polarized antenna 20B are implemented, for example, by array antennas or by directional antennas equipped with a mechanism which can adjust attitude of the antennas. This makes it possible to variably control a directivity direction and to give directivity to an arrival direction of radio waves by control from the transmission path search units 26A and 26B.

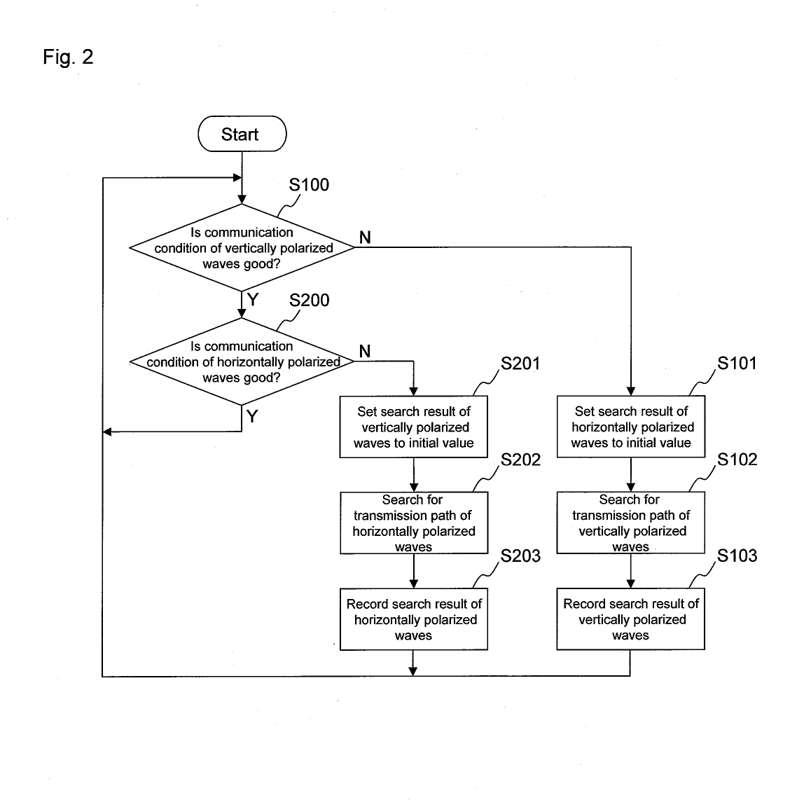

FIG. 2 is a flowchart showing an operation example of transmission path searches.

The communication condition measuring unit 25 measures a communication condition of vertically polarized waves (S100). If the communication condition is good, the communication condition measuring unit 25 measures a communication condition of horizontally polarized waves (S200). If the communication condition of the horizontally polarized waves is good, the communication condition measuring unit 25 returns to S100.

If the communication condition is not good in S100, the communication condition measuring unit 25 sets search results of horizontally polarized waves to an initial value (S101) and searches for a transmission path of the vertically polarized waves (S102).

Now, searches for a transmission path will be described. As described above, that the communication condition is not good means that the transmission path is blocked due to the existence of an obstacle such as a human body. In that case, the transmission path search unit 26A changes the directivity of the vertically polarized antenna 20A in sequence to try another transmission path such as a transmission path of reflected waves instead of the blocked transmission path. For example, the transmission path search unit 26A changes phase and gain of each antenna in the array antenna or changes orientation of the antennas using the mechanism.

The operation of changing the directivity is continued until the communication condition of the vertically polarized waves measured by the communication condition measuring unit 25 becomes good. The operation of changing the antenna directivity constitutes a transmission path search, and predetermined directivity of the antenna when the communication condition becomes good constitutes a search result.

The initial value in S101 is a predetermined directivity parameter which is used at a start time in changing the directivity of the vertically polarized antennas 20A. As described above, a result of a search already carried out by the transmission path search unit 26B to change the directivity of the horizontally polarized antenna 20B is set here as the directivity at the start time. As indicated by the statement “until the communication condition becomes good” in the previous paragraph, if the communication condition becomes sufficiently good when the initial value is set, no new search is carried out in S102 and the directivity is set to the initial value. Incidentally, if no recorded search result of the transmission path search unit 26B is available on startup of the radio apparatus on the receiving side, antenna directivity set in advance may be used by being regarded to be a search result. Furthermore, any search result recorded in the previous operation, if available before startup of the radio apparatus, may be used by being regarded to be a search result.

The search result obtained in S101 is set for the vertically polarized antenna 20A in S102 and stored in the search result storage unit 27 (S103).

After the search result is stored, the communication condition measuring unit 25 returns to S100 and continues operation. Since a search result which makes the communication condition good has been stored in S102, the communication condition measuring unit 25 goes from S100 to S200.

In S200, the communication condition measuring unit 25 measures the communication condition of horizontally polarized waves. If the communication condition is good, the communication condition measuring unit 25 returns to S100. If the communication condition is not good, the communication condition measuring unit 25 sets the search result of vertically polarized waves to the initial value (S201) and searches for a transmission path of the horizontally polarized waves (S202).

The operations in S201 and S202 are similar to the operations in S101 and S102 described earlier, but the initial value of searches in relation to vertically polarized waves in S202 is the search result already recorded in S103, i.e., the search result for the directivity of the vertically polarized antenna 20A when the communication condition became good. Since the transmission path search unit 26B starts searches for an alternative transmission path using, as the directivity at the start time, the antenna directivity which has produced the search result in the good communication condition, it is highly likely that no new search will be carried out in S202, and thus a shorter search time is required than in S102, resulting in reduced search times in the entire apparatus.

The reason why the use of a good search result for vertically polarized waves reduces the time required to search for an alternative transmission path of horizontally polarized waves is as follows. Distance between the vertically polarized antenna 13A and horizontally polarized antenna 13B on the sending side as well as distance between the vertically polarized antenna 20A and horizontally polarized antenna 20B on the receiving side are small compared to magnitude of obstacles such as human bodies which often block transmission paths. Consequently, distance between transmission paths used for multiplex communications is also small compared to the size of obstacles such as human bodies. Therefore, if one of the transmission path for vertically polarized waves and transmission path for horizontally polarized waves is blocked by movement of an obstacle, it is considered highly likely that the other of the polarized-wave transmission paths will be blocked soon. In case of blocking, an alternative transmission path is searched for, and since the distance between transmission paths used for multiplex communications is small compared to the size of obstacles, it is highly likely that a proper direction will be the same as the direction of the transmission path found for the other type of polarized waves just before the blocking.

Thus, if the directivity of the antenna is changed sequentially by setting the antenna directivity at the beginning of search, i.e., the initial value, to the antenna directivity corresponding to the other search result, i.e., the transmission path found for the other type of polarized wave (S101, S201), it is highly likely that searches will be finished quickly.

A search result obtained in S202 is set for the horizontally polarized antenna 20B and stored in the search result storage unit 27 (S203). Then, the communication condition measuring unit 25 returns to S100 again and recursively repeats the series of operations described above.

Thus, in the radio transmission apparatus which forms a plurality of transmission paths using a plurality of antennas, when the transmission path of any of the antennas which uses vertically polarized waves or horizontally polarized waves is blocked, the present first embodiment can increase the possibility of being able to reduce blocking time by carrying out a search preferentially using a search result for the transmission path of the other antenna as an initial value.

As a method for searching for an alternative transmission path when any of the transmission paths used for multiplex communications is blocked, a method which starts to search for transmission paths of all the antennas simultaneously is conceivable instead of the operation according to the flowchart described above. However, such a method will temporarily block even the antenna which is functioning properly, and thereby increase volumes of blocked information.

A method which starts searching for a transmission path of each blocked antenna individually is also conceivable, but such a method will involve as many blocking times as there are antennas, again increasing the volumes of blocked information.

In contrast to such methods, with the technique according to the present first embodiment, once the radio transmission apparatus is started and a good communication condition is established on all the transmission paths, even if any one of the transmission paths is blocked, the time required to search for an alternative transmission path can be reduced using a search result of another transmission path which maintains a good communication condition. This makes it possible to keep down the volumes of blocked information.

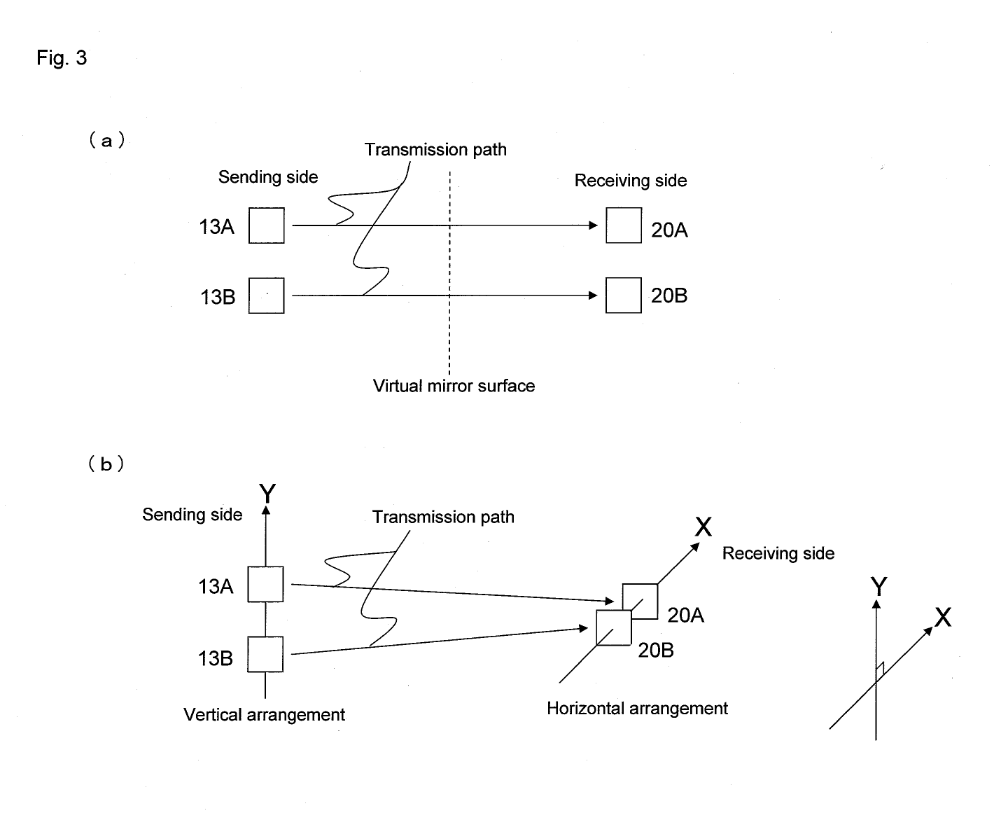

In order to use the search result of the other antenna, desirably the plurality of transmission paths used for multiplex communications are not blocked simultaneously. FIGS. 3(a) and 3(b) are diagrams showing desirable layout examples of antennas. The plurality of transmission paths used for multiplex communications will not intersect each other if an antenna arrangement on the sending side and antenna arrangement on the receiving side are set to have a mirror image relationship to each other as shown in FIG. 3(a) or the antenna arrangement on the sending side and antenna arrangement on the receiving side are made non-parallel to each other (e.g., one of the antenna arrangements is formed along a vertical direction (Y axis in FIG. 3(b)) and the other antenna arrangement is formed along a horizontal direction (X axis in FIG. 3(b)), where the Y axis and X axis are orthogonal to each other) as shown in FIG. 3(b). Thus, it will become less common for the transmission paths to be blocked simultaneously.

Also, although in the above description, the communication condition of vertically polarized waves is measured first and then the communication condition of horizontally polarized waves is measured, the order of measurements may be reversed. In short, when at least part of a plurality of transmission paths becomes unavailable for use, as long as search results of part or all of the other transmission paths (i.e., transmission paths other than those unavailable for use) are available for use, the present invention is not limited by their order of use.

### Second Embodiment

FIG. 4 is a block diagram of a radio transmission apparatus according to a second embodiment of the present invention. In the second embodiment, a variable-directivity antenna is used, as a vertically polarized antenna 13A and horizontally polarized antenna 13B, on a radio sending side and a fixed-directivity antenna is used on a radio receiving side.

Differences from the configuration of the first embodiment are that a variable-directivity antenna is on the radio sending side, not on the radio receiving side, that a search unit 1A consisting of transmission path search units 15A and 15B and a search result storage unit 16 is comprised on the sending side, not on the receiving side, that a communication condition sending unit 28 is comprised on the receiving side, and that a communication condition receiving unit 14 is comprised on the sending side. The communication condition sending unit 28 is a means to transmit communication conditions measured by the communication condition measuring unit 25 to the sending side. The communication condition receiving unit 14 is a means to receive the communication conditions transmitted from the communication condition sending unit 28. The other configurations and operations are the same as the first embodiment, and the explanation is omitted with using the same symbols. In the above configuration, the radio communications unit 1, the vertically polarized antenna 13A, the horizontally polarized antenna 13B, the search unit 1A, and the communication condition receiving unit 14 corresponds to the sending side according to the present invention and constitute the radio transmitter according to the present invention. And, the communication condition receiving unit 14 corresponds to a notified unit according to the present invention. The radio communications unit 2 corresponds to the receiving side according to the present invention.

Now, description will be given of configuration of the radio transmission apparatus having the above constitution according to the second embodiment.

In the receiving side, the communication condition sending unit 28 transmits a communication condition, which is measured by the communication condition measuring unit 25 and which is good or bad, for the sending side. The means of sending may be a time sharing communication in the frequency band the same as the radio waves from the sending side to the receiving side, may be using a different frequency band, and may be using a medium such as infrared rays instead of the electric waves. In short, it should be performed as a radio communication method including a frequency band and directivity (or No directivity) which are not blocked by an obstacle such as a human body which causes to block a transmission path of a multiplex communication. The volume of information for notifying of the communication condition is less than the volume of information of transmitting data in a multiplex communication. Therefore, the signal, which has poor directivity and is hard to be blocked and has smaller frequency, can be used.

The communication condition receiving unit 14 receives the communication condition, which is transmitted from the communication condition sending unit 28 and which is good or bad. The communication condition receiving unit 14 gives the transmission path search units 15A and 15B of the search unit 1A the communication condition. The operations of the transmission path search units 15A and 15B and the search result storage unit 16 are the same as the operations of the transmission path search units 26A and 26B and the search result storage unit 27 according to the first embodiment.

When the transmission path of any of the antennas which use vertically polarized waves or horizontally polarized waves is blocked between the sending side and the receiving side, it is possible to reduce blocking time by using a search result for the transmission path of the other antenna as an initial value preferentially and by searching for an alternative transmission path.

### Third Embodiment

FIG. 5 is a block diagram of a radio apparatus of the receiving side according to a third embodiment of the present invention. The radio apparatus of the sending side is the same as the radio apparatus of the sending side according to the second embodiment. In this embodiment, a variable-directivity antenna is used, as a vertically polarized antenna 13A and horizontally polarized antenna 13B, on a radio sending side and another variable-directivity antenna is used, as a vertically polarized antenna 20A and horizontally polarized antenna 20B, on a radio receiving side.

Differences from the configuration of the second embodiment are that a variable-directivity antenna is on the radio receiving side same as the sending side, and that a search unit 2A consisting of transmission path search units 26A and 26B and a search result storage unit 27 is comprised on the receiving side. The other configurations and operations are the same as the second embodiment, and the explanation is omitted with using the same symbols. The radio apparatus shown in FIG. 5 corresponds to the receiving side of the radio transmission system according to the present invention.

The operations of the transmission path search units 26A and 26B and the search result storage unit 27 are same as the operations of the transmission path search units 26A and 26B and the search result storage unit 27 according to the first embodiment.

By using the radio transmission system according to the third embodiment, when the transmission path of any of the antennas which use vertically polarized waves or horizontally polarized waves is blocked between the sending side and the receiving side, it is possible to reduce blocking time by using a search result for the transmission path of the other antenna as an initial value preferentially and by searching for an alternative transmission path. Furthermore, by using variable-directivity antennas as both antennas for the sending side and for the receiving side, a broadband communication in a long distance is possible using the high gain antennas in both sides.

The antennas which use vertically polarized waves and horizontally polarized waves are used as antennas in the first embodiment to the third embodiment, but the antennas which use the other polarized waves may be used. It is considered that circularly polarized antennas of which direction of rotation different from each other will be used. In this case, about a reflection wave and a direct wave, the direction of rotation is in reverse. Therefore, the signal should be replaced according to a direct wave or a reflection wave at the time of sending or receiving.

When directivity of an antenna is sharpened, a spatial multiplexing can be performed without letting polarized waves be different. It is estimated that the interference between the signals is bigger than the case of using different polarized waves. However, the communicating is possible because the mutual interference removal unit is comprised in the receiving side. In above explained embodiments, the number of the antennas on the sending side and the receiving side is two, but the number of antennas may be more than or equal to three.

In the above configuration, it is explained that the number of the antennas on the sending side and the receiving side is the same, but the number of the antennas at the sending side and the receiving side may be different. When the antennas more than the multiplex number are used, the larger number of antennas, for example, perform the radio transmission or the radio reception by the selection diversity operation or the synthetic diversity operation. On the contrary, when the antennas less than the multiplex number is/are used, the smaller number of antenna/antennas, for example, performs/perform the radio transmission or the radio reception by the time sharing. In short, the plurality of antennas of the present invention means that at least the sending side or the receiving side is comprised a plurality of antennas.

In the above configuration, a human body or the like is assumed as an obstacle, and the distance between each antenna of a plurality of antennas of the sending side and the receiving side is short compared with the obstacle size. The distance between the antennas may be set to an arbitrary length according to a place where the radio transmission apparatus is used.

In the above configuration, it is explained that the radio data transmission is performed using a polarization multiplexing or a spatial multiplexing. The present invention can be applied to other communication methods which use a plurality of transmission paths and use a radio data transmission.

In the above configuration, it is explained about a blocking of a transmission path as an example of becoming the transmission paths unavailable for use of the present invention. As explained above, the example of becoming the transmission paths unavailable may be the case that the quality of transmitted data deteriorated by exceeding a certain threshold, or may be the case that only the gain which is almost blocked condition is obtained, or may be the like case.

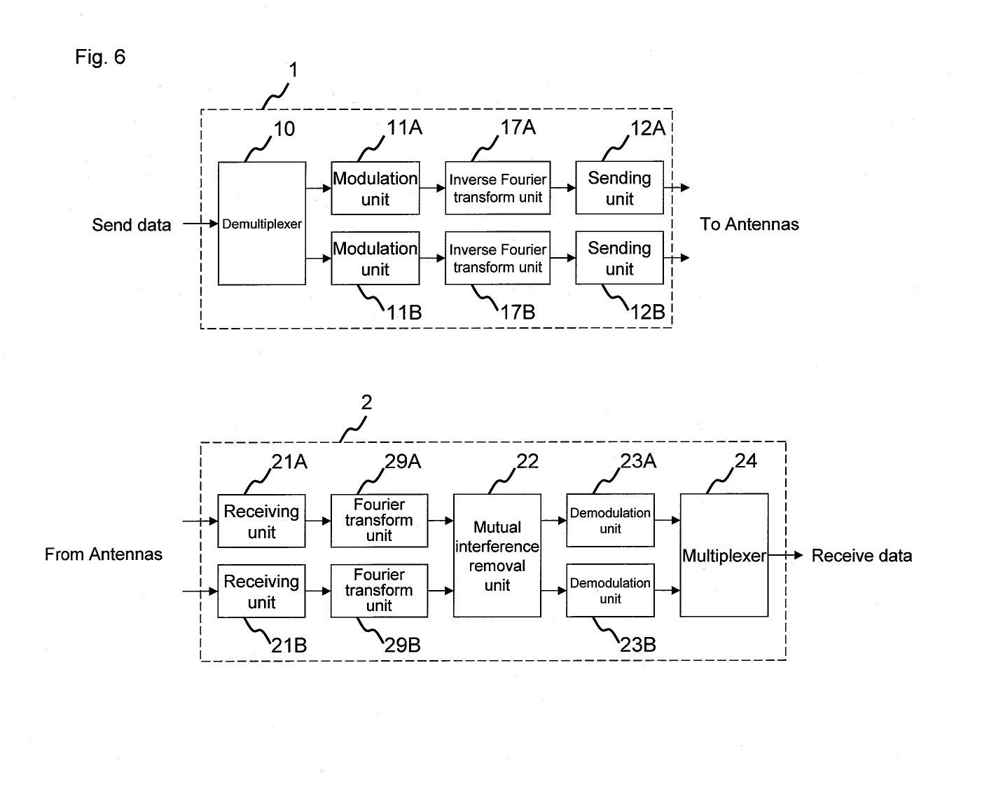

Now, description will be given of a variation of the radio communications units 1 and 2 according to the first embodiment, the second embodiment, and the third embodiment, by referring to FIG. 6. This variation is a radio communications unit adapted to the multi-carrier transmission method such as the OFDM (Orthogonal Frequency Division Multiplexing). As shown in FIG. 6, inverse Fourier transform units 17A and 17B are added at the sending side, and Fourier transform units 29A and 29B are added at the receiving side. The inverse Fourier transform units 17A and 17B generate a time waveform of a multi-carrier signal by transforming from a signal which belongs to the frequency domain and is to be sent. The Fourier transform units 29A and 29B perform Fourier transform for the time waveform of the received multi-carrier signal. That is, the time waveform is returned to the frequency domain. A quantity of a mutual interference differs depending on a carrier frequency. Therefore, it is desirable for the mutual interference removal unit 22 to be located backward from the Fourier transform units 29A and 29B.

According to the radio transmission apparatus of the present invention as described above, it becomes highly likely that a good transmission path is searched quickly. Because a downtime of the communication shortens, quantity of disappearance of the information decreases. And because the plurality of transmission paths don't intersect each other, it will become less common for the transmission paths to be blocked simultaneously.

In addition, the program according to the present invention is a program of making a computer execute the operation of steps of the radio transmission method of the present invention mentioned above, and is a program which operates in collaboration with a computer.

Moreover, the recording medium of the present invention is a recording medium which records a program for executing operation of steps of the radio transmission method of the present invention, mentioned above, by a computer, and is a recording medium for the above-mentioned program being readable by a computer and executing the above-mentioned operation with collaborating with the above-mentioned computer.

Moreover, the recording medium which records a program of the present invention is one of the present inventions.

Moreover, in one use form of the program according to the present invention, the program may be recorded in the recording medium readable by the computer, and operated in cooperation with the computer.

Moreover, in another use form of the program according to the present invention, the program may be transmitted through the transmission media, read by the computer and operated in cooperation with the computer.

Moreover, the recording media include a ROM or the like as well as an optical recording medium, a magnetic recording medium and magneto-optical recording medium.

Moreover, the computer according to the present invention described above is not limited to the pure hardware such as CPU, but may comprise a firmware, OS, or peripheral devices.

As described above, the configuration of the present invention may be implemented by software or hardware.

### INDUSTRIAL APPLICABILITY

The radio transmission method, the radio transmission system, the radio receiver and the radio transmitter according to the present invention have an effect of shortening time to search for an alternative transmission path for another transmission path which is blocked by using a polarization multiplexing or a spatial multiplexing while a radio data transmission is performed by using a plurality of transmission paths and can make the radio communication of data of the broadband with high reliability and are useful as a radio video transmission apparatus or the like.

### DESCRIPTION OF SYMBOLS

1 Radio communications unit (Sending side)
1A, 2A Search unit
2 Radio communications unit (Receiving side)
10 Demultiplexer
11A, 11B Modulation unit
12A, 12B Sending unit
13A Vertically polarized antenna
13B Horizontally polarized antenna
14 Communication condition receiving unit
15A, 15B Transmission path search unit
16 Search result storage unit
17A, 17B Inverse Fourier transform unit
20A Vertically polarized antenna
20B Horizontally polarized antenna
21A, 21B Receiving unit
22 Mutual interference removal unit
23A, 23B Demodulation unit
24 Multiplexer
28 Communication condition measuring unit
26A, 26B Transmission path search unit
27 Search result storage unit
28 Communication condition sending unit
29A, 29B Fourier transform unit

1-11. (canceled)

12. A radio transmission method comprising:
a step of searching or setting, when a radio data transmission is performed by using a plurality of transmission paths which form a polarization multiplexing or a spatial multiplexing and at least a part of the plurality of transmission paths becomes unavailable for use, another alternative transmission path instead of the part of the plurality of transmission paths which becomes unavailable for use, by using search results already obtained as to a part or all of a plurality of transmission paths other than the part of the plurality of transmission paths which becomes unavailable for use.

13. A radio transmission system comprising:
a plurality of antennas which form a plurality of transmission paths which perform a radio data transmission by using a polarization multiplexing or a spatial multiplexing;
a detecting unit which detects that at least a part of the plurality of transmission paths becomes unavailable for use when the radio data transmission is performed by using the plurality of transmission paths; and
a search unit which searches or sets, depending on a detecting result of the detecting unit, another alternative transmission path instead of the part of the plurality of transmission paths which becomes unavailable for use, wherein
the search unit searches or sets the alternative transmission path by using search results already obtained as to a part or all of a plurality of transmission paths other than the part of the plurality of transmission paths which becomes unavailable for use.

14. The radio transmission system according to claim 13, wherein
the plurality of antennas which form the plurality of transmission paths are arranged at least on a sending side or on a receiving side of the data; and
when the search unit searches or sets, the search unit searches or sets the alternative transmission path by changing directivity of antennas of the sending side and/or antennas of the receiving side which form the part of the plurality of transmission paths which becomes unavailable for use, by using directivity which is a search result of antennas of the sending side and/or antennas of the receiving side which form the part or all of the plurality of transmission paths other than the part of the plurality of transmission paths which becomes unavailable for use.

15. The radio transmission system according to claim 14, wherein
when the search unit searches or sets, the search unit sets directivity of antennas of the sending side and/or antennas of the receiving side which is a search result of the part or all of the plurality of transmission paths other than the part of the plurality of transmission paths which becomes unavailable for use in initial directivity of the antennas of the sending side and/or the antennas of the receiving side at the beginning of the search for the alternative transmission path.

16. The radio transmission system according to claim 13, wherein
the detecting unit and the search unit are arranged on the sending side or on the receiving side of the data at least.

17. The radio transmission system according to claim 13, wherein
the plurality of antennas which form the plurality of transmission paths are arranged with regard to position relations to have a mirror image relationship to each other between the sending side and the receiving side.

18. The radio transmission system according to claim 13, wherein
the plurality of antennas which form the plurality of transmission paths are arranged with regard to position relations to make a non-parallel relationship to each other between the sending side and the receiving side.

19. A radio receiver comprising:
an antenna which is used to form a plurality of transmission paths which perform a radio data transmission by using a polarization multiplexing or a spatial multiplexing, against a sending side;
a detecting unit which detects that at least a part of the plurality of transmission paths becomes unavailable for use when the radio data transmission is performed by using the plurality of transmission paths; and
a search unit which searches or sets, depending on a detecting result of the detecting unit, another alternative transmission path instead of the part of the plurality of transmission paths which becomes unavailable for use, wherein
the search unit searches or sets the alternative transmission path formed against the sending side by using search results already obtained as to a part or all of a plurality of transmission paths other than the part of the plurality of transmission paths which becomes unavailable for use.

20. A radio transmitter comprising:
an antenna which is used to form a plurality of transmission paths which perform a radio data transmission by using a polarization multiplexing or a spatial multiplexing, against a receiving side;
a notified unit which receives from the receiving side a notification showing that at least a part of the plurality of transmission paths becomes unavailable for use when the radio data transmission is performed by using the plurality of transmission paths; and
a search unit which searches or sets, depending on a performance of the notified unit, another alternative transmission path instead of the part of the plurality of transmission paths which becomes unavailable for use, wherein
the search unit searches or sets the alternative transmission path formed against the receiving side by using search results already obtained as to a part or all of a plurality of transmission paths other than the part of the plurality of transmission paths which becomes unavailable for use.

21. A non-transitory computer-readable medium having a program stored thereon, wherein the program causes a computer to execute the radio transmission method according to claim 12.

22. The radio transmission system according to claim 14, wherein
the detecting unit and the search unit are arranged on the sending side or on the receiving side of the data at least.

23. The radio transmission system according to claim 15, wherein
the detecting unit and the search unit are arranged on the sending side or on the receiving side of the data at least.

24. The radio transmission system according to claim 14, wherein
the plurality of antennas which form the plurality of transmission paths are arranged with regard to position relations to have a mirror image relationship to each other between the sending side and the receiving side.

25. The radio transmission system according to claim 15, wherein
the plurality of antennas which form the plurality of transmission paths are arranged with regard to position relations to have a mirror image relationship to each other between the sending side and the receiving side.

26. The radio transmission system according to claim 16, wherein
the plurality of antennas which form the plurality of transmission paths are arranged with regard to position relations to have a mirror image relationship to each other between the sending side and the receiving side.

27. The radio transmission system according to claim 14, wherein
the plurality of antennas which form the plurality of transmission paths are arranged with regard to position relations to make a non-parallel relationship to each other between the sending side and the receiving side.

28. The radio transmission system according to claim 15, wherein
the plurality of antennas which form the plurality of transmission paths are arranged with regard to position relations to make a non-parallel relationship to each other between the sending side and the receiving side.

29. The radio transmission system according to claim 16, wherein
the plurality of antennas which form the plurality of transmission paths are arranged with regard to position relations to make a non-parallel relationship to each other between the sending side and the receiving side.
